(19) United States
(12) Patent Application Publication
(10) Pub. No.: US 2003/0160352 A1
(43) Pub. Date: Aug. 28, 2003

(54) Method for the production of conductive composite material

(76) Inventor: Erik Middelman, Arnhem (NL)

Correspondence Address: Oliff & Berridge, PO Box 19928, Alexandria, VA, 22320, US

(21) Appl. No.: 10/204,132

(22) PCT Filed: Feb. 19, 2001
(86) PCT No.: PCT/NL01/00137

(30) Foreign Application Priority Data
Feb. 17, 2000 (NL) 1014403

(51) Int. Cl. B29C 43/00

(52) U.S. Cl. 264/104; 264/325

(57) ABSTRACT

The invention is related to a method for the production of sheet like material that can be used in applications where polymer based material has to conduct electric current at low impedance, especially for application in electrodes, like the electrodes of polymer electrolyte membrane (PEM) fuel cells, the sheet material being electrically conductive composite material comprising a non conductive polymer binder and electrically conductive compounds. The method according to this invention has as its objective to provide a method for large-scale production of electrical conductive sheet like material in which the disadvantages of the prior art are avoided.

The invention is related to a method for the production of sheet like material that can be used in applications were polymer based material has to conduct electric current at low impedance, especially for application in electrodes, like the electrodes of polymer electrolyte membrane (PEM) fuel cells, the sheet material being electrically conductive composite material comprising a non conductive polymer binder and electrically conductive compounds

Fuel cells are known since the discovery of Sir William Grove in the 19^{th} century. Several types of fuel cells have been developed since. One of these fuel cell types is the PEM fuel cell. A PEM fuel cell is comprises typically a proton conducting membrane with a catalyst-containing electrode on both sides. Such an assembly is called a MEA (membrane electrode assembly). Typically these MEA's ar placed between electrically conducting plates, often called bi-polar plates to form a single fuel cell, or if more of these cells are stacked such a assembly is called a fuel cell stack. The main functions of the bi-polar plates are conduction of electrical current from one electrode to another electrode of a in series connected fuel cell, distribution of hydrogen and oxygen or an oxygen containing gas, removal of reaction water, sealing between the gas channels and the atmosphere. Known bi-polar or mono poar plates are made from metal like stainless steel, coated metal like gold-coated stainless steel, metal foam, synthetic graphite, and conductive composite material. Al these materials have their specific advantages and drawbacks as publicly known from several patents and many publications in the open literature.

Application of conductive composite material comprising non-conductive polymer binders, and electrically conductive powders for application in electro chemical cells is for example known from U.S. Pat. No. 4,214,969. However no economically feasible production method is described.

A method for the production of electrical conducive composite material for application in electrochemical cells, like fuel cells is disclosed in DE 1995019542721. According to this method a solid with good thermal conductivity and a polymer melt is mixed homogeneously. Subsequently this powder is extruded to a tube like intermediate product. This intermediate is according to the invention cut open, and pressed flat to form a flat sheet like material. Application of the process according to DE 1995019542721 yields a product with a high content of conducting solid, however this method has some serious drawbacks. Homogeneous mixing of the polymer melt and the conductive solid is difficult if a high solid content is essential. In addition to that the subsequent cooling and grinding is expensive. An other drawback of the method of DE 1995019542721 is orientation during extrusion leading to non-isotropic material properties and a direction dependent coefficient of thermal expansion. Not only the mechanical properties are affected, but also the electrical property like the conductivity perpendicular to the flow direction is usually reduced.

The method according to this invention has as its objective to provide a method for large-scale production of electrical conductive sheet like material in which in which the disadvantages of the prior art are avoided. The process starts with powdered raw materials. A mixture is made comprising electrical conductive powder (material A) particles with a size of 10-300 micron, a second conductive powder (material B) has elementary particles of less than 1 micron, typically 0,2 micron, and the non-conductive polymer powder (material C) has a particle size between 0,1 and 500 micron. Besides materials A, B and C, the mixture can also contain non conductive fibers, conductive fibers, whiskers, hydrophobing additives, additives for hydrophilisation, and other additives that improve process ability and or material properties. The polymer can be a thermoplastic polymer, a thermosetting polymer or an elastomer. Suitable conductive fillers are metal powders, metal fibers, graphite, graphite fibers, carbon fibers, electrical conductive oxide powders like fluorine doped Tin oxide and Aluminum doped zinc oxide or powders coated with a conductive layer and carbon blacks. Suitable thermoplastic polymers are fluorinated polymers like PTFE, PVDF, PVF, PFA, FEP, THV, poly olefins like LD-PE, HD-PE, UHMWPE, PP, high temperature thermoplastics like PEN, PPS, PEI, PEEK. The powders are preferably mixed below the melting point of material C. A low viscous liquid like water is mixed with the powder mixture to form a homogeneous pate like compound. This low viscous liquid can be water, a appropriate organic solvent or water solvent mixtures. According to an embodiment of this invention the paste like compound is applied to a heated or heatable surface like a heated drum or a heated endless process belt. The paste is dried at an increased temperature that is preferably at the same temperature level as the boiling point of the low viscous liquid. After evaporation of the low viscous liquid, the temperature is further increased to above the melting point of material C, or above the melting point of one ore more of the other materials in the mixture to make the powder stick together. The dried and heated plate like sheet is fed to a calander or calander like apparatus, a belt calander, or a double belt press. Between the drums, or between the belts the porous plate like sheet is densified to the required level of porosity. This porosity level is preferably kept between 0% and 50%. If a belt calander or a double belt press is used the material can be kept under pressure for a certain time above the melting temperature of material C, attaining improved mechanical properties and less porosity. The plate like material produced according to the process still contains some voids or porosity. These voids could have a negative influence on mechanical properties and electrical and thermal conductivity. Surprisingly it was found that the process ability of the porous intermediate product is better than an intermediate with identical composition but no porosity. The material is an intermediate product for the production of articles like electrode plates and plates of heat exchangers. In this forming process the intermediate material is heated to a temperature above the melting temperature of material C, placed in a compression mold and pressed. In this process the mold temperature is below the melting point of material C. In another embodiment of the invention also process starts also with powdered raw materials. The electrical conductive powder (material A) particles with a size of 10-300 micron, a second conductive powder (material B) has elementary particles of less than 1 micron, typically 0,2 micron, and the non-conductive polymer powder (material C) has a particle size between 0,1 and 500 micron. Besides materials A, B and C, the mixture can also contain non conductive fibers, conductive fibers, whiskers, hydrophobing additives, additives for hydrophilisation, and other additives that improve procesability and or material properties. The polymer can be a thermoplastic polymer, a thermosetting polymer or an elastomer. Suitable conductive fillers are metal powders, metal fibers, graphite, graphite fibers, carbon fibers, electrical conductive oxide powders like fluorine doped Tin oxide and Aluminum doped zinc oxide, powders that are coated with a conductive layer and carbon blacks. Suitable thermoplastic polymers are fluor polymers like PTFE, PVDF, PVF, PFA, FEP, THV, poly olefins like LDPE, HD-PE, UHMWPE, PP, high temperature thermoplastics like PEN, PPS, PEI, PEEK. The powders are preferably mixed below the melting point of material C. Optionally after a homogeneous mixture has been obtained, the powder mixture is heated to a temperature just above the melting temperature of material C to cause some agglomeration, and thus avoiding demixing.

According to an embodiment of this invention the powder mixture or the stabilized, agglomerated powder mixture is applied to a heated or heatable surface like a heated drum, a foil or a heated endless process belt. The temperature is further increased to above the melting point of material C, or above the melting point of one ore more of the other materials in the mixture to make the powder stick together. The dried and heated plate like sheet is fed to a calander or calander like apparatus, a belt calander, or a double belt press. Between the drums, or between the belts the porous plate like sheet is densified to the required level of porosity. A porosity level of the intermediate between 0% and 90% is preferred. If a belt calander or a double belt press is used the material can be kept under pressure for a certain time above the melting temperature of material C, attaining improved mechanical properties and less porosity. The plate like material produced according to the process still contains some voids. These voids have a negative influence on mechanical properties and electrical and thermal conductivity of the intermediate product, but surprisingly have no negative effect on the pressed end product. The material is an intermediate product for the production of articles like electrode plates and plates of heat exchangers. In this forming process the intermediate material is heated to a temperature above the melting temperature of material C, placed in a compression mold and pressed. In this process the mold temperature is below the melting point of material C.

The processes according to the invention and the material prodused according the invention have advantages over the state of the art technologies and materials. Low cost basics raw materials are used like polymer powders. The polymer powders (material C) are preferably produced (polymerized) as powder by emulsion or suspension polymerization. The conducting powder (material A) is preferably course synthetic graphite. Material C is preferably an ultra fine conducing graphite or carbon black produced from low cost heavy oil fractions. Mixing is performed below the melting temperature to keep easy material flow and avoiding unwanted orientation in the material. Because unwanted orientation is avoided, the end product, like a bi-polar plate is more dimensional stable than material produced according to known processes. Applications of thermoplastic binders make the material reusable. According to the invention shaped parts can be pulverized and the obtained powder can be processed by the processing method of the invention is if it was the original powder mixture of materials A, B and C.

### EXAMPLE 1

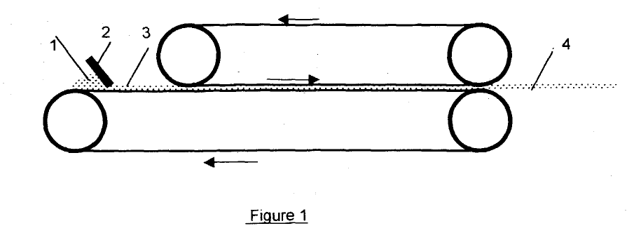

A stirred vessel was filled with; 30 kg de mineralized water, 10 kg electrically conductive graphite with an average particle size of 150 micron, 0,5 kg carbon black, and 4 kg PVDF powder with a average particle size of 100 micron. The material was mixed with a high shear mixer type Ultra Turax at 20.000 rpm. This paste (FIG. 1, item 1) was casted on the protruding lower belt of a double belt press of FIG. 1 and spread uniformly by a doctor blade (2). The water was evaporated in the drying zone (3) were the temperature was increased to 180° C. The dried material was fed trough the heated double belt press were it was heated up to 300° C. at a pressure of 2.000.000 Pa and cooled to 100° C. in the last section of the double belt press. Total residence time in the double belt press at 300° C. was two minutes. Obtained was a sheet like conductive composite material (4).

What is claimed is:

1. A method for the production of an electrical conductive intermediate product comprising electrical conductive solids, and a non conductive polymer binder wherein the intermediate material is produced by means of a continuous pressing machine

2. A method according to claim 1 wherein the raw materials are mixed and homogenized as powders to form a powder mixture.

3. A method according to claim 1 or 2 wherein the continuous pressing machine is an isobaric double belt press.

4. A method according to claim 1 or 2 wherein the continuous pressing machine is an isochoric double belt press.

5. A method according to any of the preceding claims wherein the non conductive polymer is a fluorine containing polymer like PTFE, PVDF, PVF, PFA, FEP or THV.

6. A method according to claim 5 wherein the preferred fluorinated polymer is PVDF.

7. A method according to any of the preceding claims wherein the non conductive polymer is a poly olefin like LD-PE, HD-PE, UHMWPE, PP,

8. a method according to claim 5 wherein the preferred olefin polymer is HD-PE.

9. A method according to any of the preceding claims wherein the sheet like intermediate product has porosity between 0 and 90%.

10. A method according to any of the preceding claims wherein the intermediate product is reinforced with fibers like glass fibers, metal fibers, carbon fibers, graphite fibers or aramid fibers

11. A method according to any of the preceding claims wherein the intermediate product is used for the production of shaped parts like electrodes or fuel cell plates or the conductive part of fuel cell plates

12. A method according to any of the preceding claims wherein shaped parts of conductive composite material are pulverized and this powder is used for the production of the conductive intermediate product.

13. A method according to any of the preceding claims wherein the production process contains; mixing of powder like raw materials with or without an low viscous liquid, distribution of the powder mixture or paste on an foil like carrier, a endless process belt or a drum, optionally drying, heating to a temperature above the melting point, or if there is no melting point above the Tg of de non conductive polymer, forming to a sheet like material by rolling or pressing, and cooling to a temperature below the melting point or the Tg of the non conducting polymer.

14. A method of forming shaped parts wherein the process comprises the following steps;
Cutting the intermediate product to the right size, weight or volume to prepare a pre-form
Heating of the preform to a temperature above Tm if semi crystalline polymer is used or above Tg if amorphous polymer is used.
Placing the heated perform in a suitable mold in a suitable pressing machine like a hydraulic press, the mold having a temperature below Tg or Tm of the polymer and preferably avoiding direct contact between the mold surface and the heated preform prior to closing of the mold.
Closing of the mold at high pressure to form the perform to a negative of the mold halves
Release from the mold.
